(19) United States
(12) Patent Application Publication
(10) Pub. No.: US 2012/0077455 A1
(43) Pub. Date: Mar. 29, 2012

(54) EMERGENCY COMMUNICATION AND DISPATCHING SYSTEM

(75) Inventor: Shin-Tseng YEH, Hsin Chuang City (TW)

(73) Assignee: UNICATION CO., LTD., Hsin Chuang City (TW)

(21) Appl. No.: 13/238,259

(22) Filed: Sep. 21, 2011

(30) Foreign Application Priority Data
Sep. 29, 2010 (TW) 099133192

(51) Int. Cl. H04W 4/22

(52) U.S. Cl. 455/404.1

(57) ABSTRACT

An emergency communication and dispatching system has an operating console and a plurality of 2-way radios. 2-way radios are carried separately by the staff on duty and communicated with the operating console or other staff. Of which, the operating console could receive the event information and pictures from the reporting source and transmit them to the 2-way radio of any staff, while a camera could be used by the staff to take the pictures at the scenes. The 2-way radio is used to transmit the pictures and position data to the operating console or the receiver of other staff, so as to improve the communication and execution efficiency of public security or military personnel.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

REFERENCE TO AN APPENDIX SUBMITTED ON COMPACT DISC

Not applicable.

### BACKGROUND OF THE INVENTION

1. Field of the Invention

The present invention relates generally to a communication and dispatching system, and more particularly to an innovative one which permits transmission of emergency-related pictures between the operating console and a plurality of 2-way radios via a RF channel 2. Description of Related Art Including Information Disclosed Under 37 CFR 1.97 and 37 CFR 1.98.

A common dispatching system (e.g.: logistic system for police, fire brigade, medical services, rescue operations and military forces) comprises at least a center console and a plurality of 2-way radios. Of which, a 2-way radio is often carried by a personnel on duty for two-way communication with the operating console or other staff. Moreover, a 2-way radio for transmitting or broadcasting information from the operating console to the working staff is only limited to transmit acoustic and literal information while meeting the requirements for transmitting complex emergencies.

For instance, in the event of a robbery, using the conventional dispatching system, it is almost impossible to describe on-site situations or the features involving the suspects or vehicles acoustically or literally. So, the policemen could not identify the suspects so to as interrogate or arrest them immediately. In particular, monitors are extensively used at crossroads or indoors and also linked to a safety control center, or their images are taken as the basis for reporting and handling the cases. In such a case, it is possible to waste human resources and lose opportunity of cracking down on crimes if the images are not immediately available for the staff on duty.

Hence, it is very necessary to provide an emergency communication and dispatching system that enables transmission of pictures and data via predefined frequency between the operating console and working staff, such that acoustic and literal information could be communicated between the operating console and 2-way radios, or between 2-way radios.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The emergency communication and dispatching system of the present invention comprises at least an operating console, which could, via either of Internet, GSM, PSTN or cable, receive relevant emergency information sent from reporting source such as mobile phone with photographing functions, digital camera or monitoring VCR. Such information includes at least an image or picture data. After receiving the event information, the operating console could select at least an important frame from the images or picture data to prepare at least a picture. The digitalized picture data are recoded and modulated into RF signals on predefined frequency band, then sent to at least one or all staff through the predefined frequency band, whilst a 2-way radio carried by the staff receives the event information, which are shown as picture data on the display of 2-way radio by means of at least demodulation and decoding, enabling the staff to implement their assigned tasks. Besides, a camera could also be used by the staff to take pictures at the scenes, then the picture data are input to 2-way radio, which recodes and modulates the picture data into RF signals and then transmits to the operating console or 2-way radio of other staff through RF channel, thus enabling real-time reporting of on-site conditions/request for support.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a layout diagram of a preferred embodiment of the present invention.

FIG. 2 is a block diagram of the 2-way radio's circuit of the present invention.

### DETAILED DESCRIPTION OF THE INVENTION

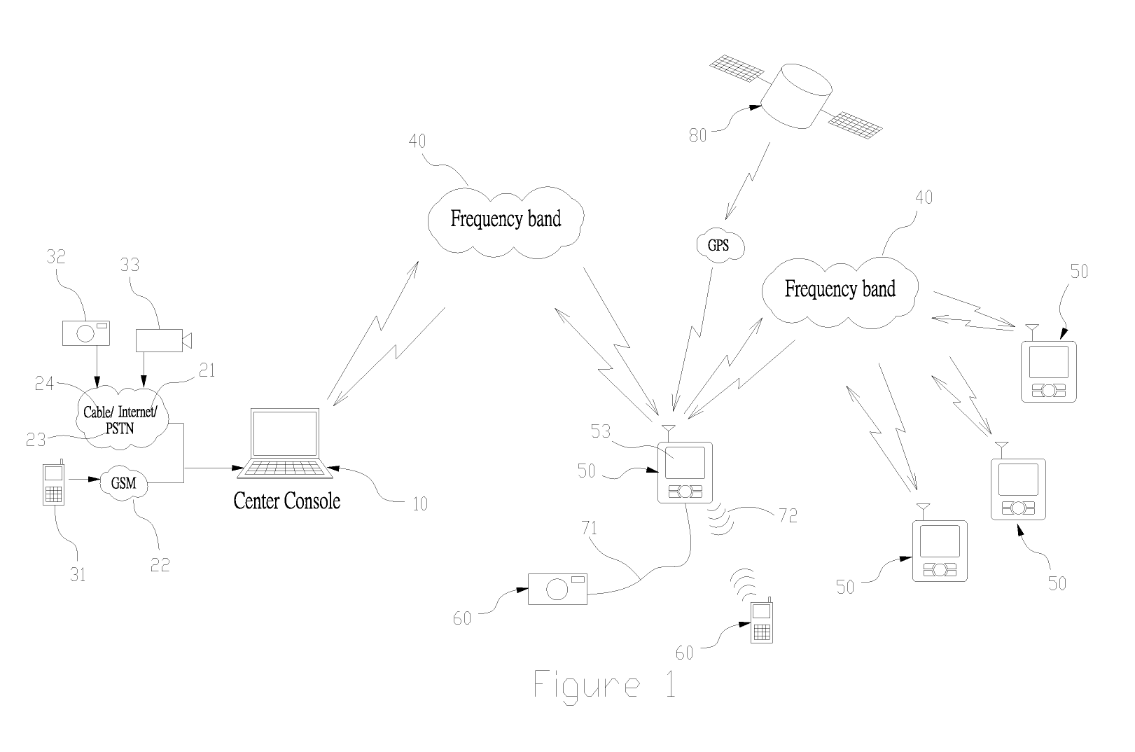

Referring to FIG. 1, the emergency communication and dispatching system of the present invention comprises at least an operating console 10, which could, via either of Internet 21, GSM 22, PSTN 23 or cable 24, receive relevant emergency information sent from a reporting source (data source) such as: mobile phone 31 with photographing functions, digital camera 32 or monitoring VCR 33. Such information includes at least an image or picture data, and also acoustic or literal information sent by said reporting source or in combination with other telecom devices. After receiving the event information, the operating console 10 could select at least an important frame from the images or picture data to prepare at least a picture. The digitalized picture data are recoded and modulated into RF signals on predefined frequency band, then sent to at least one or all staff through RF channel, whilst 2-way radio 50 carried by the staff receives the event information, which are shown as picture data on the display of 2-way radio 50 by means of at least demodulation and decoding, enabling the staff to implement their assigned tasks. Also, a camera 60 could also be used by the staff to take the pictures at the scenes, then the picture data are input to 2-way radio 50, which recodes and modulates the picture data into RF signals and then transmits to the operating console 10 or 2-way radio 50 of other staff through RF channel, thus enabling real-time reporting of on-site conditions/request for support.

In the emergency communication and dispatching system, 2-way radio 50 serves as either an analog or digital element. After acquiring picture (image) data, said mobile phone 31, digital camera 32 or monitoring VCR 33 could transmit picture data to the operating console 10 directly, or via a computer device in wired or wireless way.

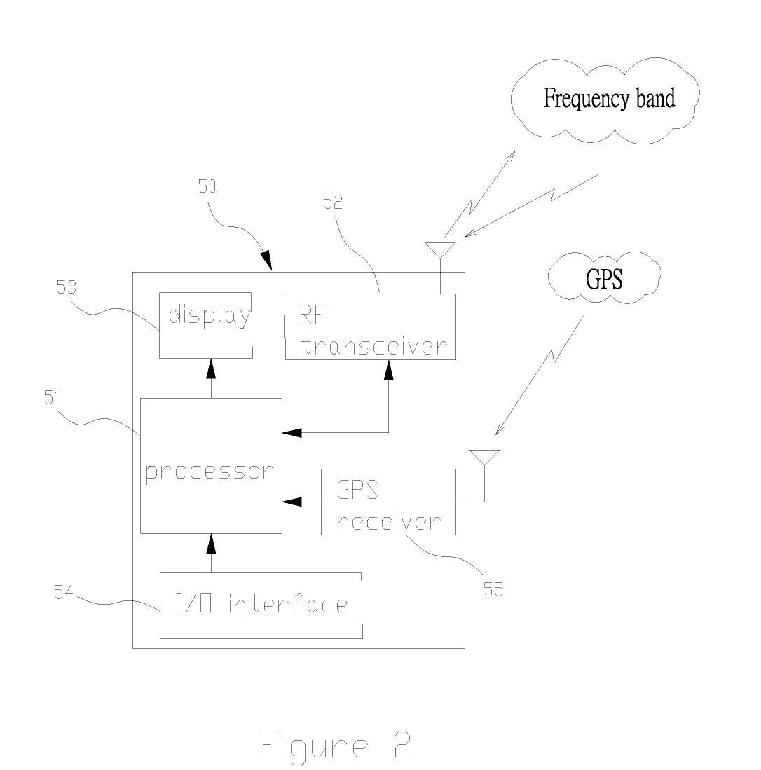

Referring also to FIG. 2, the 2-way radio 50 contains at least a processor 51, an RF transceiver 52, a display 53 and an I/O interface 54, of which the processor 51 is electrically connected with the aforementioned elements, and then connected with loudspeaker, microphone and input unit, for the purpose of acoustic communication.

According to the structure of said 2-way radio 50, after RF transceiver 52 receives the picture data from the operating console 10 or other wireless telecom devices through a predefined RF frequency and then transmits to the processor 51, the picture data are demodulated and decoded by the processor 51 and then transmitted to the display 53 of 2-way radio 50 for the users. Moreover, 2-way radio 50 could receive the picture data from a camera 60 through I/O interface 54 and transmit to the processor 51, then the digitalized picture data are recorded by the processor 51 and modulated on existing frequency band, and next transmitted to RF transceiver 52, which transmits to the operating console 10 or other wireless telecom devices through RF channel In this way, 2-way radio 50 could receive and transmit the picture data in existing RF system.

Of which, 2-way radio 50 is also provided with a GPS receiver 55, which could receive the position coordinate of existing 2-way radio 50 from GPS satellite 80, and also transmit the coordinate information while sending out the pictures. In addition, the coordinate information could be sent along with acoustic or literal communication.

Of which, said camera 60 is a mobile phone with photographing function, a digital camera or an auxiliary unit assembled onto 2-way radio 50.

The camera 60 could input the picture data to 2-way radio 50 using a signal wire 71 or through Bluetooth system 72.

In the event of a robbery against a bank or supermarket, the supervisors of the operating console 10 find out this event from the monitor, or are informed by the working staff of the bank or supermarket to watch the video records or pictures sent from the mobile phone 31, digital camera 32 or monitoring VCR 33, they could prepare the important frames into pictures and then transmit RF signals via frequency band 40 to 2-way radio 50 of all working staff or the staff on duty. While receiving the commands from 2-way radio 50, the staff on duty could also watch pictures from the monitor of 2-way radio 50, so as to find out the suspected robbers, vehicles or on-site situations. Meanwhile the assigned staff could immediately try to capture or arrest the suspects.

In the case where a working staff on duty finds out an emergency or is assigned at the scenes requesting for support, a camera 60 could be used to take the pictures of field conditions or important information, and input the picture data into the portable 2-way radio 50, which, via the help of a frequency band 40, transmits the pictures and the position data to the operating console 10 or 2-way radio 50 of other staff or other receiving devices (e.g.: those for public security, rescue and medical services) by means of RF signals, thereby allowing to report clearly the status of events and request for support.

1. An emergency communication and dispatching system, comprising at least: an operating console, which could receive relevant emergent information sent from reporting source; the information includes at least an image or picture data; after receiving the event information, the operating console could select at least a frame from the images or picture data to prepare at least a picture; the picture data are recoded and modulated into RF signals on predefined frequency band, then sent to at least one or all staff through RF channel, whilst 2-way radio carried by the staff receives the event information, which are shown as picture data on the display of 2-way radio by means of at least demodulation and decoding; besides, a camera could also be used by the staff to take the pictures at the scenes, then the picture data are input to 2-way radio, which recodes and modulates the picture data on predefined frequency band and then transmits to the operating console or other wireless devices on RF channel

2. The structure defined in claim 1, wherein said operating console receives image or picture data sent from the reporting source via either of Internet, GSM, PSTN or cable.

3. The structure defined in claim 2, wherein the devices used to send image or picture data to the operating console comprise at least: mobile phone with photographing functions, digital camera or monitoring VCR.

4. The structure defined in claim 1, wherein said 2-way radio is either an analog or a digital system.

5. The structure defined in claim 4, wherein said 2-way radio contains at least a processor, an RF transceiver, a display and an I/O interface, of which the processor is electrically connected with the aforementioned elements; when the picture data received from RF transceiver are transmitted to the processor, the data are demodulated and decoded by the processor, then transmitted to the display; 2-way radio could receive the picture data from a camera via an I/O interface and transmit to the processor, which then transmits the picture data to RF transceiver by means of at least encoding and modulation.

6. The structure defined in claim 5, wherein said 2-way radio is also provided with a GPS receiver, which could receive the position coordinate of 2-way radio from GPS satellite, and also transmit the coordinate information along with the picture data, acoustic or literal data.

7. The structure defined in claim 5, wherein said 2-way radio is further provided with a camera unit.

8. The structure defined in claim 5, wherein said I/O interface includes at least the interface of signal wire and Bluetooth unit.
